(19) United States
(12) Patent Application Publication
(10) Pub. No.: US 2005/0229415 A1
(43) Pub. Date: Oct. 20, 2005

(54) Level with cylindrical handle

(76) Inventor: Charles D. Kim, Raleigh, NC (US)

Correspondence Address: JANSSON, SHUPE & MUNGER & ANTARAMIAN, LTD, 245 MAIN STREET, RACINE, WI, 53403, US

(21) Appl. No.: 10/826,539

(22) Filed: Apr. 16, 2004

(51) Int. Cl. G01C 9/00

(52) U.S. Cl. 33/451

(57) ABSTRACT

A level for facilitating handling during use is disclosed. The level includes element-contacting means, level-indicating means mounted with respect to the element-contacting means; and a cylindrical handle portion mounted with respect to the element-contacting means. In preferred embodiments, the level-indicating means is mounted in the cylindrical handle portion. The level is also described as comprising a body including a cylindrical portion and a trapezoidal portion connected at an interface, a vial mounted in the body at a predetermined angular relationship to the level face and at least one hand-grip aperture formed in the trapezoidal portion adjacent to the cylindrical portion to allow a user to grip the cylindrical portion.

### FIELD OF THE INVENTION

This invention relates to geometric instruments and, more particularly, to levels (sometimes referred to as “spirit levels” used by carpenters and the like.

### BACKGROUND OF THE INVENTION

Levels are used by carpenters, masons, drywallers and the like for helping to assure that surfaces are horizontal, vertical, or at a specified angular relationship to the horizon. A typical level includes at least two vials, one each for ascertaining whether a surface is “level,” i.e., horizontal, or “plumb,” i.e., vertical.

A level vial comprises a tube made of clear glass or, preferably, clear plastic (acrylic, for example), the barrel-shaped cavity of which is partially filled with a liquid such as mineral spirits. The vial is not completely filled and a bubble is thereby formed when the vial is closed. Typically, two marker rings are applied to the outside of the vial in positions to visually divide the cavity into three portions of about equal length. Level and plumb conditions are ascertained by noting the position of the bubble with respect to the marker rings.

Typically, levels are provided with two planar and parallel surfaces spaced from each other by a web portion. Often level-indicating vials are placed in one of the parallel surfaces and in the web portion. The web portion also often includes apertures for hanging the level on a hook or for being gripped by a user.

A problem with such apertures is that they require the user to grip a planar surface and, thus, the edges of the planar surface when carrying or holding the level by gripping the aperture. While such a requirement may not seem too burdensome, the user may also be carrying other items in his hand and may be required to squeeze tightly to hold such items, causing the edges of the level to press into his hand. In addition, some levels are quite large and may require tight handling simply due to their length and weight.

In addition, such perpendicular surfaces and edges provide surfaces to come into contact with other tools or other things during use and can become nicked or scratched. Such nicks and scratches provide raised edges which can cut a user's hand when gripped.

Furthermore, levels having two planar, parallel surfaces typically are designed from optimal use from one surface. Therefore, a user may frequently, perhaps 50% of the time, have to flip the level over to use the preferred side after placing the level in position to measure.

An improved level which has a sturdy handle formed from with curvilinear surfaces only would be an important advance in the art. Furthermore, such a level which provides such a handle within the typical profile of a level would additionally improve upon the prior art. Finally, an improved level comprising a rounded handle which can be gripped while the level's flat surface engages an element to be measure would solve these noted problems in the prior art.

### OBJECTS OF THE INVENTION

It is an object of the invention to provide an improved level overcoming some of the problems and shortcomings of the prior art.

Another object of the invention is to provide a level which includes a cylindrical handle portion.

Another object of the invention is to provide a level permitting handling without contact with an edge on the level.

Still another object of the invention is to provide an improved level having a trapezoidal portion formed integrally with a cylindrical handle.

Another object of the invention is to provide a level having a cylindrical portion centered above a symmetrical trapezoidal portion to allow for use while gripping the cylindrical portion.

Yet another object of the invention is to provide a level including a bubble vial in a cylindrical handle portion.

Another object of the invention is to provide a level which has a smooth exterior surface. How these and other objects are accomplished will become apparent from the following descriptions and from the drawings.

### SUMMARY OF THE INVENTION

In at least one embodiment, the invention is a level for facilitating handling during use and between uses. The level provides for more comfortable and easier handling and represents a significant advance over the state of the art by providing novel elements, including a cylindrical handle portion.

In certain embodiments the level comprises a body including a cylindrical portion and a trapezoidal portion connected at an interface, the trapezoidal portion having a level face for measuring a surface; at least one vial mounted in the body at a predetermined angular relationship to the level face; and at least one hand-grip aperture formed in the trapezoidal portion adjacent to the cylindrical portion to allow a user to grip the cylindrical portion. One of the vials is preferably mounted in the cylindrical portion at a predetermined angular relationship to the level face. A second vial is preferably mounted in the cylindrical and trapezoidal portions at another predetermined angular relationship to the level face.

The cylindrical portion may have a oval or circular cross section and a diameter defining a cylindrical portion width. The level face is parallel to the diameter and, in certain embodiments, the level face has a width greater than the cylindrical portion width. In other embodiments the level face has a width equal to the cylindrical portion width. In still other embodiments, the level face has a width less than the cylindrical portion width.

It is preferred that the cylindrical and trapezoidal portions overlap. In such embodiments a portion of the cylindrical portion can be considered to be part of the trapezoidal portion and a portion of the trapezoidal portion can be considered to be part of the cylindrical portion. The cylindrical and trapezoidal portions may be integrally formed.

In some embodiments, two hand-grip aperture are formed in the trapezoidal portion adjacent to the cylindrical portion to allow a user to grip the cylindrical portion, the hand-grip apertures being spaced apart along the interface.

The invention can also be described as a level for facilitating handling and use. Such level comprises a planar bottom face surface extending from a first edge to a second edge, the face surface for contacting an element to be measured; a vial containing a bubble for measuring the levelness of the element, the vial mounted at a determined angular relationship to the face surface; a planar front surface portion extending upward from the first edge at an acute angle to the face surface and terminating at a front upper edge; a planar rear surface portion extending upward from the second edge at an acute angle to the face surface and terminating at a rear upper edge; a cylindrical portion mounted to the front and rear upper edges; and a hand-grip aperture formed in the front and rear surface portions adjacent to the front and rear upper edges and the cylindrical portion to allow a user to grip the cylindrical portion.

In such an embodiment the vial is preferably mounted in the cylindrical portion. A second vial may be mounted in a recess positioned in the front and rear surface portions and extending into the cylindrical portion, the second vial being set at another determined angular relationship to the face surface.

The cylindrical portion preferably defines a curvilinear surface and the hand-grip aperture is preferably defined by an aperture surface extending from the front surface portion to the rear surface portion and by a portion of the curvilinear surface. The user may grip the curvilinear surface to hold the level, thereby providing a comfort to the user. The aperture surface may be parallel to the face surface.

The invention may also be described as a level for facilitating handling in which the level comprises element-contacting means; level-indicating means mounted with respect to the element-contacting means; and a cylindrical handle portion mounted with respect to the element-contacting means. The element-contacting means allows the user to contact an element to be measured, such as a building surface, with the level. The level-indicating means is preferably mounted in the cylindrical handle portion and the cylindrical handle portion is preferably connected to a lower body portion which includes the element-contacting means. In certain embodiments, the handle portion and lower body portion are integral.

The level may comprise one, two, or more hand-grip apertures located in the lower body portion adjacent the handle portion. In such levels, the cylindrical portion is preferably connected to the lower body portion at web portions surrounding the hand-grip aperture(s).

### BRIEF DESCRIPTION OF THE DRAWINGS

FIG. 1 is a perspective view of a level in accordance with an embodiment of the invention.

FIG. 2 is top view of the level of FIG. 1.

FIG. 3 is front view of the level of FIG. 1

FIG. 4 is bottom view of the level of FIG. 1

FIG. 5 is side view of the level of FIG. 1

### DETAILED DESCRIPTION OF PREFERRED EMBODIMENTS

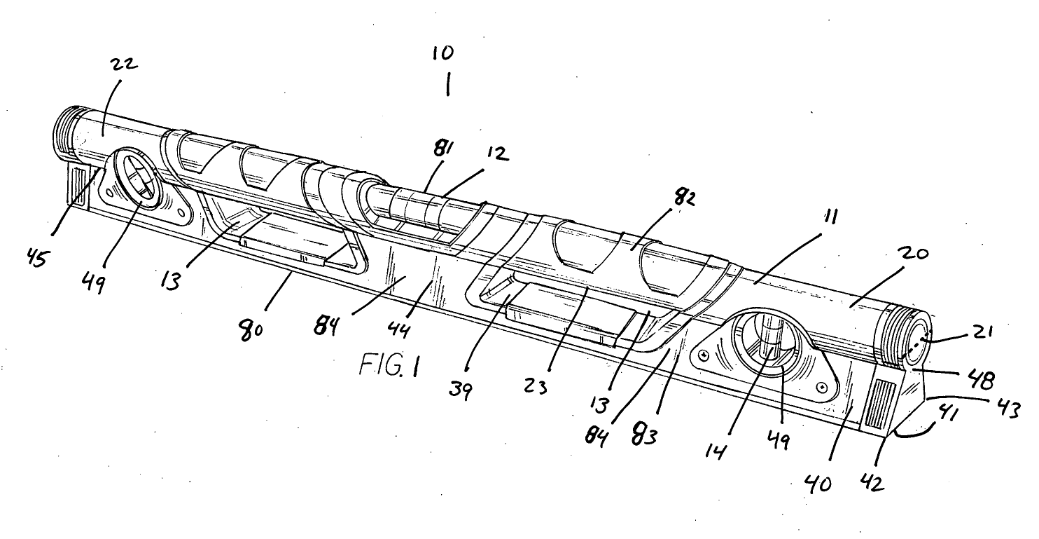

FIG. 1 is a perspective view of level 10. Level 10 includes a body 11 including a cylindrical portion 20 and a trapezoidal portion 40 which meet at interface 48. Cylindrical portion 20 has a circular cross section and a diameter 21 defining the width of cylindrical portion 20. Diameter 21 is parallel to level face 41 and may have a width greater than, equal to, or less than level face 41. Curvilinear surface 22 bounds cylindrical portion 20. First vial 12 is positioned within cylindrical portion 20.

Trapezoidal portion 40 includes a level face or face surface 41 which is used to contact an element, such as surface 8 (see FIG. 3), to determine its levelness. Face 41 extends from a first edge 42 to a second edge 43. A planar front surface portion 44 extends upward from first edge 42 at an acute angle to face 41 and terminates at front upper edge 45. A planar rear surface portion 46 (see FIG. 5) extends upward from second edge 43 at an acute angle to face 41 and terminates at rear upper edge 47. Front and rear upper edges 45,47 are coextensive with interface 48. Trapezoidal portion 40 includes recesses 49 in surface portions 44,46 to receive vials 14 which are positioned at a determined angular relationship to face 41. A second vial 14 is mounted in the cylindrical and trapezoidal portions 20,40 perpendicular to level face 41.

Aperture 13 is positioned in trapezoidal portion 40 adjacent cylindrical portion 20 such that a portion 23 of curvilinear surface 22 defines aperture 13 and provides a smooth, non-edged surface to be gripped by a user. Aperture surface 39 defines the lower portion of aperture 13 and is preferably parallel to face 41.

Element-contacting means 80 is positioned on level 10 to contact an element such as surface 8 to determine its levelness. Level-indicating means 81 is provided to indicate the levelness of the element-contacting means 80 and, thus, the element 8. Cylindrical handle portion 82 includes level-indicating means 81 and extends from one end of the level to the other. Lower body portion 83 connects cylindrical handle portion 82 to element-contacting means 80. Web portion 84 provides such connection adjacent to apertures 13.

As shown, first vial 12 is mounted in cylindrical portion 20 parallel to level face 41. Level 10 includes two hand-grip apertures 13 formed in trapezoidal portion 40 adjacent to cylindrical portion 20 to allow a user to grip the cylindrical portion 20 and handle level 10. Hand-grip apertures 13 are spaced apart along interface 48 and are separated from one another by web portion 84. Apertures 13 are preferably dimensioned to receive a user's hand.

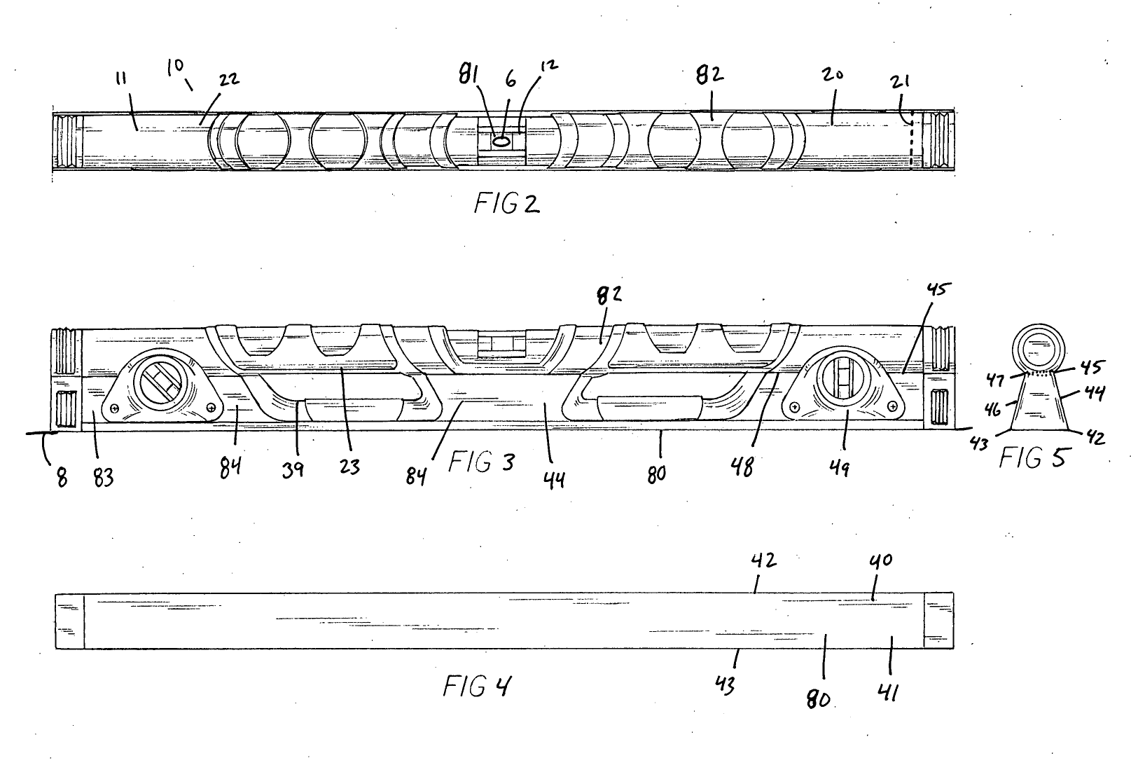

FIG. 2 shows the top of level 10. As shown bubble 6 is centered in vial 12 indicating that face 41 is level. FIG. 3 shows level 10 positioned on element or surface 8. FIG. 4 shows face 41 of trapezoidal portion 40. FIG. 5 shows how cylindrical and trapezoidal portions 20,40 overlap such that a portion of cylindrical portion 20 is within the bounds of trapezoid portion 40 and vice versa.

Cylindrical portion 20 and trapezoidal portion 40 are preferably intragrally formed from a plastic, though other materials may be used. Face 41 is preferably a titanium member fixed to trapezoidal portion 40 though other materials, particularly metals, may be used. Portions of curvilinear surface 22, aperture surface 39, and the end caps of body 11 include elastomeric materials such as acrylonitrile butadiene styrene and thermoplastic rubber to provide durability, friction, and resistance to the level 10 during wear and tear. Vials 12,14 are preferably acrylic though other material may be used.

Thus, it should be apparent that there has been provided, in accordance with the present invention, a level that fully satisfies the objectives and advantages set forth above.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A level comprising:
a body including a cylindrical portion and a trapezoidal portion connected at an interface, the trapezoidal portion having a level face for measuring a surface;
the cylindrical portion defining a substantially uniform circular cross section with a diameter, the diameter in a parallel relationship with the level face of the trapezoidal potion;
at least one vial mounted in the body at a predetermined angular relationship to the level face; and
at least one hand-grip aperture formed in the trapezoidal portion adjacent to the cylindrical portion to allow a user to grip the cylindrical portion.

2. The level of claim 1 wherein a first vial is mounted in the cylindrical portion at a predetermined angular relationship to the level face.

3. The level of claim 2 wherein a second vial is mounted in the cylindrical and trapezoidal portions at another predetermined angular relationship to the level face.

4. (canceled)

5. The level of claim 1 wherein the cylindrical and trapezoidal portions overlap.

6. The level of claim 1 wherein two hand-grip apertures are formed in the trapezoidal portion adjacent to the cylindrical portion to allow a user to grip the cylindrical portion, the hand-grip apertures being spaced apart along the interface.

7. The level of claim 1 wherein the cylindrical and trapezoidal portions are integrally formed.

8. A level for facilitating handling and use, the level comprising:
a planar bottom face surface extending from a first edge to a second edge, the face surface for contacting an element to be measured;
a vial containing a bubble for measuring the levelness of the element, the vial mounted at a determined angular relationship to the face surface;
a planar front surface portion extending upward from the first edge at an acute angle to the face surface and terminating at a front upper edge;
a planar rear surface portion extending upward from the second edge at an acute angle to the face surface and terminating at a rear upper edge;
a cylindrical portion mounted to the front and rear upper edges; and
a hand-grip aperture formed in the front and rear surface portions adjacent to the front and rear upper edges and the cylindrical portion to allow a user to grip the cylindrical portion.

9. The level of claim 8 wherein the vial is mounted in the cylindrical portion.

10. The level of claim 9 further comprising a second vial mounted in a recess positioned in the front and rear surface portions and extending into the cylindrical portion, the second vial being set at another determined angular relationship to the face surface.

11. The level of claim 8 wherein the cylindrical portion has a circular cross section and a diameter defining a cylindrical portion width and wherein the face surface is parallel to the diameter, the face surface having a width greater than the cylindrical portion width.

12. The level of claim 8 wherein the cylindrical portion defines a curvilinear surface and wherein the hand-grip aperture is defined by an aperture surface extending from the front surface portion to the rear surface portion and by a portion of the curvilinear surface, the user gripping the curvilinear surface to hold the level.

13. The level of claim 12 wherein the aperture surface is parallel to the face surface.

14-20. (canceled)

21. A level for facilitating handling, the level comprising:
a cylindrical handle portion having a substantially uniform diameter and including two ends defining a length therebetween;
an element-contacting means extending from the cylindrical handle portion and defining a length substantially matching the length of the cylindrical handle portion; and
level-indicating means mounted with respect to the element-contacting means.

22. The level of claim 21 wherein the level-indicating means is mounted in the cylindrical handle portion.

23. The level of claim 21 wherein the element-contacting means includes a lower body portion.

24. The level of claim 23 wherein the handle portion and lower body portion are integral.

25. The level of claim 23 further comprising two hand-grip apertures located in the lower body portion adjacent the handle portion.

26. The level of claim 23 further comprising a hand-grip aperture located in the lower body portion adjacent the handle portion.

27. The level of claim 18 wherein the cylindrical portion is connected to the lower body portion at web portions surrounding the hand-grip aperture.
